(19) United States
(12) Patent Application Publication
(10) Pub. No.: US 2003/0041787 A1
(43) Pub. Date: Mar. 6, 2003

(54) Firearms display & storage safe

(76) Inventor: Edward F. Gerstenkorn, Vacaville, CA (US)

Correspondence Address: William S. Bernheim, 255 N. Lincoln St., Dixon, CA, 95620, US

(21) Appl. No.: 09/944,920

(22) Filed: Sep. 4, 2001

(51) Int. Cl. E06B 3/34

(52) U.S. Cl. 109/73

(57) ABSTRACT

A firearms storage safe which transforms into a display case for firearms contained therein.

### BACKGROUND OF THE INVENTION

### FIELD OF THE INVENTION

This invention relates generally to a firearms storage safe which transforms into a display case suitable for use in public gun stores.

### DESCRIPTION OF THE PRIOR ART

Counter-type display cases are widely employed as a means of displaying firearms for sale in gun stores. Frequently, these cases have frames made of wood or metal with fronts and tops of glass. Current federal law requires that all handguns that are on daily display must be secured in safes or vaults during non-business hours. Each morning the handguns must be moved from secure storage to the display cases, and each evening the handguns must be returned to secure storage.

The recurrent daily transfer of the handguns and other firearms from secure storage to display cases and back poses several problems, some of which are of material economic detriment to the merchant. For one, store space is not being used efficiently, as during business hours the space dedicated to the secure storage is not in use, and during non-business hours that space dedicated to the display area is necessarily left empty. Square footage in desired business regions is almost always priced to a maximum level the market will bear, and a continual non-use of such space is wasteful and burdensome upon the merchant. None of the current art teaches a system or apparatus for the display and/or storage of firearms that solves this problem. As a result, considering the above mentioned regulation requiring that all handguns which are on daily display must be secured in safes or vaults during non-business hours, in light of the failure of the prior art to present a viable alternative to such daily transfer, the costly non-use of business zoned square footage is essentially forced upon the merchant.

Other problems associated with a daily transferring of handguns or other firearms result from the fact that guns and other firearms are essentially made aesthetically appealing, and subsequently have a certain variety of delicateness. More specifically, new handguns and other firearms, often sold at a considerable value, have high qualities of surface finishes and polish. These high quality finishes are not limited to the functional metal parts of the firearms. Often, the woodwork of a rifle stock or pistol grip is intricate, with finishes as high in quality as that found on the finest wooden furniture. Similarly, designs or motifs, including intricate scenes, are commonly etched into the receiver portions of shotguns for bird hunting. These finishes and intricate artworks commonly present on many types of firearms frequently determine the ultimate value of the firearm. It is common practice for firearm merchants to offer discounts to clients for purchasing such firearms when the motifs are damaged, even slightly. The daily handling of these firearms: moving them, locking them in place in their display case, removing them and placing them in a vault, poses every time a myriad possibilities for the marring of brand new expensive merchandise by the inherent fact that each neighboring item, i.e. each firearm, is made primarily of steel, as are many components of the display case and vault. Consequently, metal to metal contact, and metal to wood contact, often with sharp or acute edges, occurs in and among the handguns and firearms themselves. Therefore, in an attempt to preserve the full value of the rather costly merchandise, the firearms must be moved with great care, requiring substantial time. As many gun stores are operated by their proprietors, the matter is not one only of an economic waste, but one of lost personal time, and increased fatigue, upon already heavily worked individuals. This poses personal safety risks as well, especially because stores selling handguns and firearms are most likely to be targeted by thieves after closing; i.e. when most stores are secured, but a firearm sole proprietor may be occupied delicately removing, transferring, and carefully positioning in secure storage a large quantity of valuable items he is attempting to prevent the damage of.

Therefore, it can be appreciated that there exists a continuing need for a new and improved system and apparatus for the display and secure storage of guns and other firearms which eliminates the need for their regular transfer, provides a near effortless transition from display conditions to secure storage conditions, while immobilizing and isolating the firearms both from contact with one another or from potentially damaging components of their display case and/or vault.

### SUMMARY OF THE INVENTION

In view of the foregoing disadvantages inherent in the known types of firearm display systems and firearm storage systems and devices now present in the prior art, the firearms display and storage safe according to the present invention departs substantially from the conventional designs and concepts of the prior art. In doing so it provides an apparatus primarily developed for the purpose of allowing the near instantaneous safe and secure storage of firearms on display without concurrent transfer of the displayed firearms, and all the inherent disadvantages of such transfer. As such, the general purpose of the present invention is to provide a new and improved dual purpose firearms display and storage system which has all the advantages associated with combining the benefits of current display systems with the benefits of current secure storage systems, and has none of the disadvantages.

To attain this, the present invention essentially includes a main body with moveable end pieces capable of serving also as doors that, when in the display mode, together are disposed to define a generally rectangular outlined display case including a medially disposed fixed back plate and a left and a right fixed partial side plates; one (1) fixed partial side plate proximal each left and right side of the fixed back plate. The left and right fixed partial side plates generally lie in a plane that is generally perpendicular to a plane within which the fixed back plate is considered to lie. A fixed top plate and a fixed bottom plate are attached to the fixed back plate and left and right fixed partial side plates. Additionally, the two (2) moveable end pieces are each one during the display mode separately connected to a different one of the two (2) fixed partial side plates by hinges disposed on that edge of each fixed partial side plate which is most distal the fixed back plate. The moveable end pieces may be L shaped when viewed in a cross section taken along a plane perpendicular to their long dimension.

Thus, in a particular embodiment of the present invention, each moveable end piece includes two (2) sides: (i) a side proximal that fixed partial side plate to which it connects and which, during the display mode, lies in a plane perpendicular to the plane within which is generally disposed the fixed back plate, and (ii) a side distal the fixed partial side plate to which it connects and which, during the display mode, lies in a plane generally parallel to the plane within which is generally disposed the fixed back plate. Because each one (1) of the moveable end pieces connects respectively to one (1) of the fixed partial side plates, the moveable end pieces thus are capable of being used as left and right moveable doors. Thus, the moveable end pieces may be referred to as moveable doors. Subsequently, the left and right moveable end pieces are referred to as left and right moveable doors.

The backing of all portions of the display case are made of heavy steel plate, or suitable vault grade laminate, or other material suitable for use in a secure storage vault in substitution of heavy steel plate. The display case is configured such that with minimal movements and effort the moveable doors of the display case may be folded forward and inward as permitted by the hinges connecting the moveable doors to the fixed partial side plates. Defined within and about the moveable doors and other portions of the main body of the display case and storage safe are secure closure means including metal bolts (such as “pins”) and receiving apertures for said metal bolts, cooperatively coupled via mechanical linkages to a locking device accessible from the exterior of one of the moveable doors. The mechanical linkages move the metal bolts laterally and/or vertically to secure the moveable doors to the main body and to each other by way of the receiving apertures located therein. The locking device may be any suitable locking device, including a digital or rotary locking device. When the moveable doors are closed, the display case with heavy steel plate becomes a secure storage safe, with fire resistant seals and materials, having fixable mounting means for the displayed firearms configured and arranged so that upon closing of the moveable doors the firearms, previously displayed, are (i) securely enclosed within the cavity of the storage safe, and (ii) restrained and fixed to their respective display surfaces so that the impetus resultant of shutting movement velocities and stopping decelerations of the moveable doors is incapable of dislodging the mounted firearms from their display components. Result: The display case is able to be readily, rapidly and easily transformed into a secure storage safe meeting all regulations, and firearms previously displayed during the present inventions display mode become safely encapsulated and stored within the cavity of the display case now turned secure storage safe.

It is an object of the present invention to provide an effective method and system for the display and secure storage of firearms that eliminates the need for any transfer of the firearms.

It is a further object of the present invention to provide an effective method and system for the display and secure storage of firearms that both complies with all regulations and serves the public safety while eliminating the need for any transfer of the firearms.

It is yet a further object of the present invention to provide an effective method and system for the display and secure storage of firearms that eliminates the need for any transfer of the firearms and also immobilizes and secures the firearms from undesired contact with one another or objects surrounding them, including display case and vault components.

It is yet a further object of the present invention to provide an effective method and system for the display and secure storage of firearms that eliminates the need for any transfer of the firearms and provides a ready and rapid method of securing the displayed firearms during non-business hours, emergencies and the like.

It is yet a further object of the present invention to provide a relatively simple and technologically affordable display area for firearms that eliminates the need for any transfer of the firearms to a separate secure storage area.

It is yet a further object of the present invention to provide a relatively simple and technologically affordable display area for firearms that both eliminates the need for any transfer of the firearms to a separate secure storage area, while providing affordable display and storage capabilities compatible with the needs and abilities of retailers.

It is yet a further object of the present invention to provide an effective method and system for the display and secure storage of firearms that eliminates both the need for any transfer of the firearms and the need for a separate secure storage safe, thereby eliminating both wasteful use of space and tedious and risky transfer effort.

These and other objects and advantages will be apparent to those skilled in the art in light of the following disclosure, claims and accompanying drawings.

### BRIEF DESCRIPTION OF THE DRAWINGS

FIG. 1 is a perspective illustration of the present invention with one of the doors thereof in an open and display orientation.

FIG. 2 is a plan view of the front side of the display case and storage safe of the present invention.

FIG. 3 is a plan view of the external right side of the display case and storage safe of the present invention.

FIG. 4 is a plan view taken from above illustrating the basic outline of the display case and storage safe of the present invention with the doors thereof in a transitory position and partially opened.

FIG. 5 is a plan view of the top of the right door of the display case and storage safe of the present invention.

FIG. 6 is a plan view of the top of the left door of the display case and storage safe of the present invention including firearms display mounting apparatus.

FIG. 7 is a side plan view of a mounting apparatus seen in FIG. 6 used to support and immobilize a firearm mounted on the display side surface of a door of the present invention.

FIG. 8 is a plan view taken from above of the present invention in the fully open and display position where a portion of the top plate has been cut away so as to permit the viewing of firearms mounted and displayed on display surfaces including of the fixed back plate of the present invention.

### DESCRIPTION OF THE PREFERRED EMBODIMENT(S)

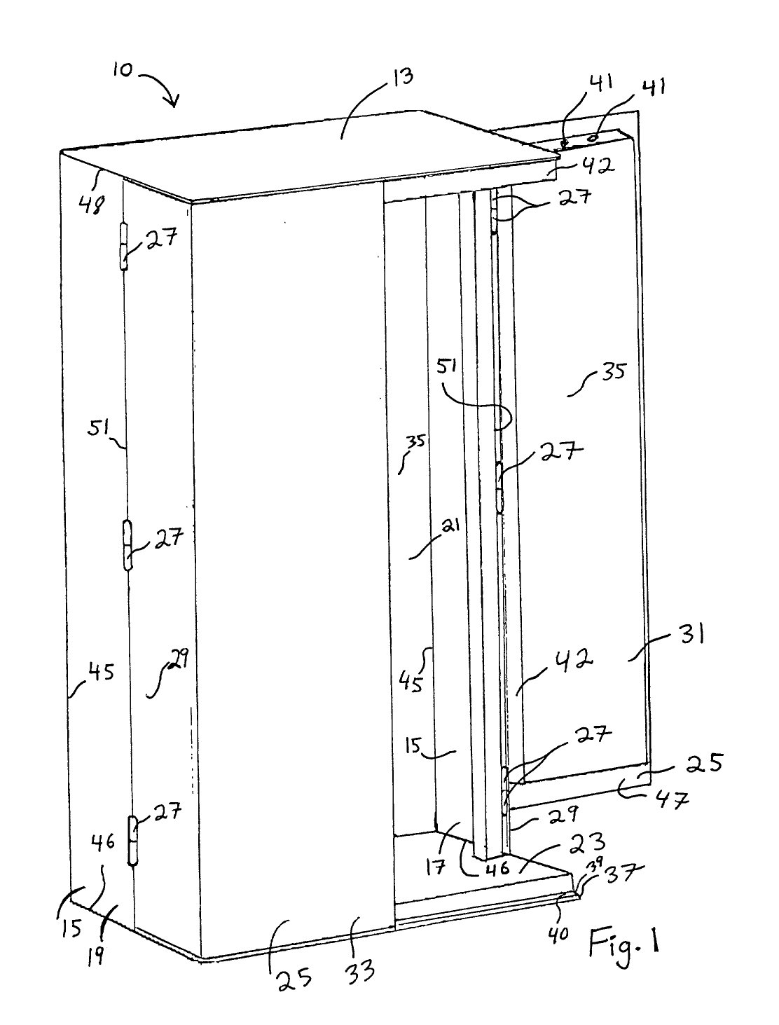

Referring to FIG. 1 a firearms display case and storage safe main body as generally indicated by arrow line 10 includes fixed top plate 13, fixed partial side plates 15, including fixed left partial side plate 17 and fixed right partial side plate 19, a fixed back plate 21, fixed bottom plate 23, and moveable doors 25. Moveable doors 25 are moveably attached to fixed partial side plates 15 by maximally strong tamper resistant hinges 27 attached to fix partial side plates 15 at the shorter sides 29 of moveable doors 25. Each fixed partial side plate 15 has four (4) sides: back side 45 attached to fixed back plate 21, bottom side 46 attached to fixed bottom plate 23, top side 48 attached to fixed top plate 13, and fourth side 51 to which are connected via hinges 27 moveable doors 25. Moveable doors 25 include left and right moveable doors 31 and 33, respectively. In FIG. 1 only the inside surfaces of fixed back plate 21 and left moveable door 31 are visible. Similarly not visible in FIG. 1 is top side 48 of fixed left partial side plate 17, for which reference is made to FIG. 3. Also not seen in FIG. 1 is the exterior side surface of fixed left partial side plate 17, thus number line 29 points to and touches the fourth side 51 (see FIG. 3) of fixed left partial side plate 17, exposed by the open position of left moveable door 31. As seen, display surfaces 35 are included upon fixed back plate 21 and left moveable door 31, as are preferably covered or upholstered with an attractive material, including fire resistant materials. The exterior and main structural portions of firearm display case and storage safe main body 10 are preferably of a heavy steel plate. For example, fixed top plate 13, fixed partial side plates 15, fixed back plate 21, fixed bottom plate 23 and moveable doors 25 are preferably of a heavy steel plate. However, other suitable materials, including laminates suitable for vault structures, may substitute for heavy steel plate.

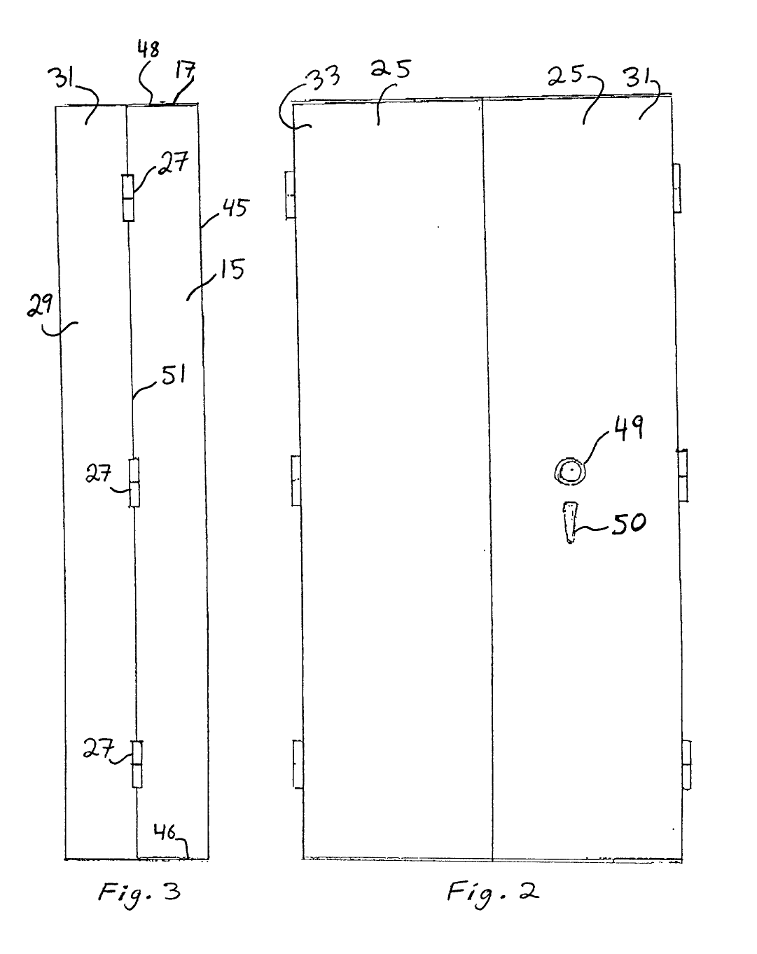

Defined within and about the moveable doors 25 and other portions of the display case and storage safe main body 10 are secure closure means including metal bolts (such as “pins”) 41 and receiving apertures for said metal bolts (not shown) cooperatively coupled via mechanical linkages (not shown) to a locking device 49 (see FIG. 2) accessible from the exterior of one of the moveable doors 25. The mechanical linkages move the metal bolts 41 laterally and/or vertically (laterally disposed bolts not shown) to secure the moveable doors 25 to the main body 10 and to each other by way of the receiving apertures located therein. As described by example for a fire resistant door sealing means suitable for other door closure abutments effected by the closure and affixing of moveable doors 25 to main body 10, fixed bottom plate 23 includes beveled lower edge 37 including indented lip 39 upon which is disposed a strip of material making up fire resistant door seal 40. Other fire resistant materials are included in interior bulkhead abutment portions 42, included upon interior portions of main body 10. When the lower side edge 47 of moveable door 25 abuts indented lip 39, the combination of fire resistant interior bulkhead abutment portions 42 and fire resistant door seal 40 serve to create an effective fire and heat barrier for protection of the contents when firearms display case and storage safe main body 10 is in the secured storage mode.

FIG. 2 is a plan view taken from the front side of firearm display case and storage safe main body 10 disposed in the secured storage mode. As seen, the front side of main body 10 includes moveable doors 25, including left moveable door 31 and right moveable door 33. Accessible from the exterior of left moveable door 31 is locking device 49 and handle 50. Locking device 49 as shown is a rotary locking device, however, any suitable locking device may be used in substitution, including digital locking devices. Locking device 49 is cooperatively coupled via mechanical linkages (not shown) to metal bolts 41 defined within and about moveable doors 25. Operation of locking device 49 manipulates metal bolts 41 via the mechanical linkages to either position metal bolts 49 within the apertures (not shown), defining a locked and secured orientation to main body 10, or to remove metal bolts 41 from the apertures, permitting the display mode of the firearms display case and storage safe main body 10.

In reference to FIG. 3 is shown a plan view of the external left side of the display case and storage safe of the present invention. As shown, hinges 27 moveably adjoin fixed left partial side plate 17 to the shorter side 29 of left moveable door 31. Hinges 27 are disposed along fourth side 51 of fixed right partial side plate 19. Also shown are the four sides of fixed partial side plate 15: back side 45 which attaches to fixed back plate 21, bottom side 46 which attaches to fixed bottom plate 23, top side 48 which attaches to fixed top plate 13, and fourth side 51 to which is connected via hinges 27 left moveable doors 31.

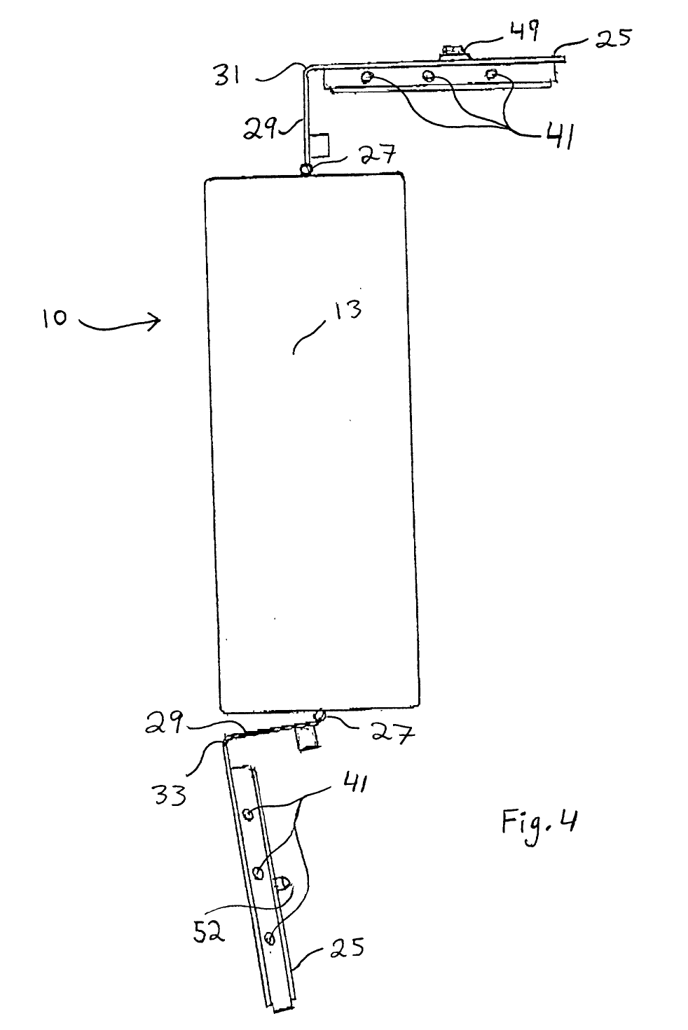

In reference to FIG. 4 is shown a plan view taken from above illustrating the basic outline of the display case and storage safe of the present invention with moveable doors 25 thereof in a transitory position and partially opened. Seen also are top plate 13, shorter sides 29 of left and right moveable doors 31, 33 respectively, metal bolts 41 and locking device 52. As evidenced, moveable doors 25 are “L” shaped in cross section when viewed from above. Moveable door 33 includes interior handle 52 for assistance in the rapid and ready shutting of moveable door 33.

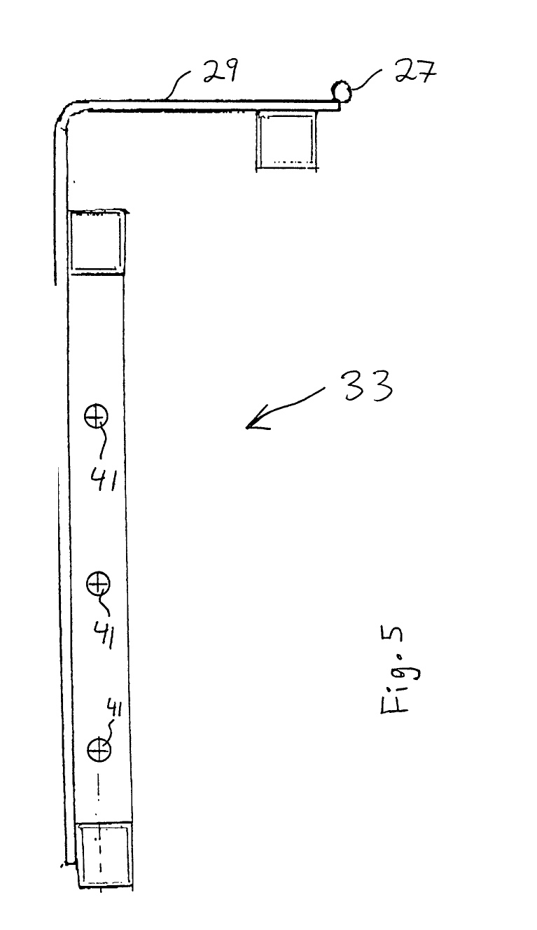

In reference to FIG. 5 is shown a plan view of the top of right moveable door 33 of the instant embodiment of the present invention. Right moveable door 33 includes metal bolts 41 and shorter side 29.

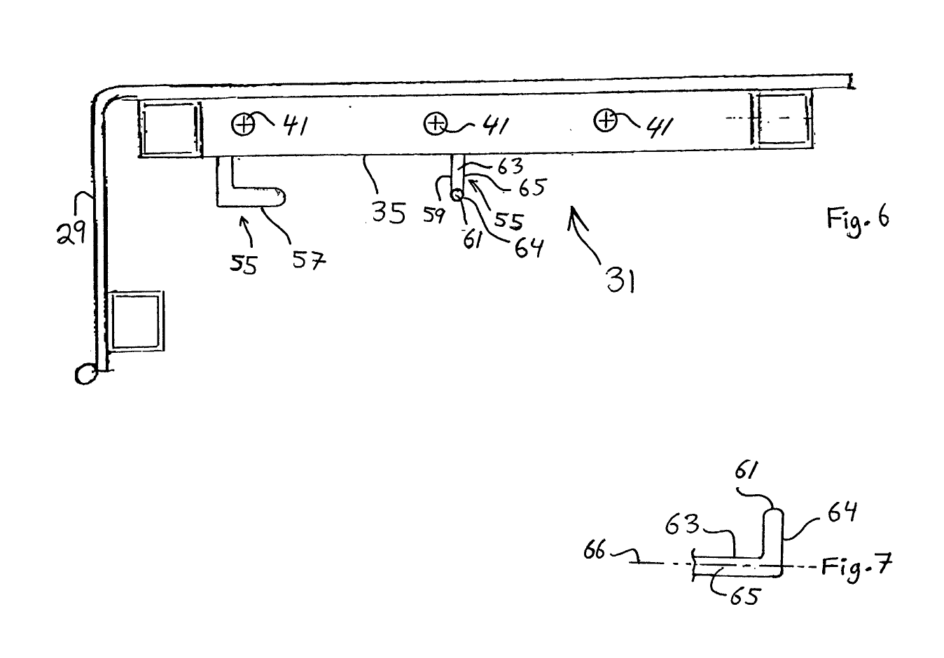

In reference to FIG. 6 is shown a plan view of the top of left moveable door 31 of the instant embodiment of the present invention. Left moveable door 31 also includes metal bolts 41 and shorter side 29. To aid in understanding how mounting apparatuses 55 restrain and fix firearms to the display surface 35 of moveable door 25, mounting apparatus barrel plug 57 and trigger guard hook 59 are shown in place on the display surface 35 of left moveable door 31. In explanation, barrel plug 57 is made of a flexible rubber like material capable of being flexed so as to aid in its insertion into or withdrawal from the barrel at the muzzle end of a firearm. Trigger guard hook 59 is of similar construction and generally hook shaped, including top side 61, vertically oriented hook arm 64 (see also FIG. 7) and horizontally oriented rest arm 65. The orientation of trigger guard hook 59 is such that the top side 61 of trigger guard hook 59 is pointed upwards, and the weight of the firearm is born on the upper surface 63 of arm 65. Axis line 66 passing through the long dimension of arm 65 is generally parallel to fixed bottom plate 23.

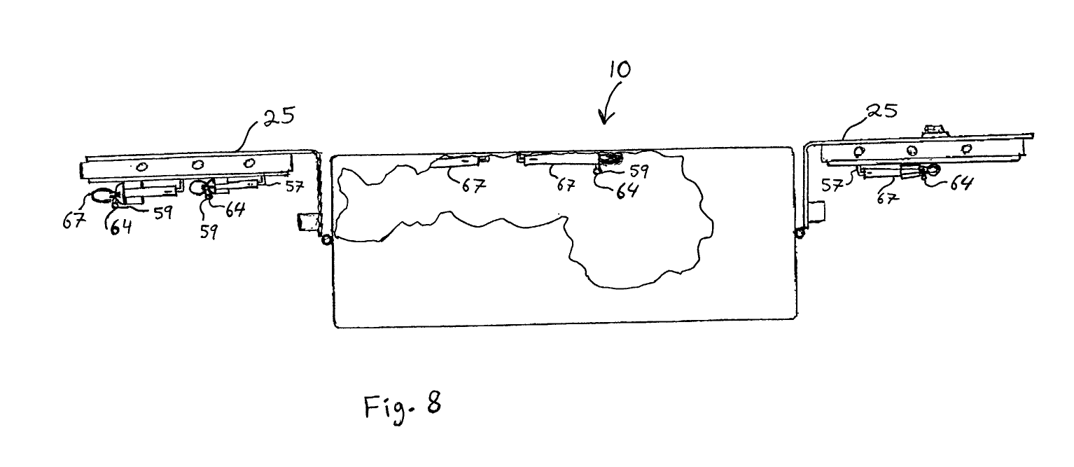

FIG. 8 shows a plan view taken from above of the present invention in the fully open and display mode position where a portion of the top plate has been cut away so as to permit the viewing of firearms mounted and displayed on the display surfaces 35 of fixed back plate 21 of the present invention. As shown, handguns 67 are held in place by barrel plugs 57 and vertically orientated hook arms 64 of trigger guard hooks 59. Result: firearms display case and storage safe of the present invention may be readily, rapidly, easily and even suddenly closed and locked into the secure storage mode without risk of dislodging displayed firearms from their display positions securely against display surfaces 35. Consequently, space is saved, tedium and risk have been eliminated, displayed firearms are not transferred, have been immobilized and do not risk damage. Resultantly, the foregoing objects of the present invention have been attained.

Although the present invention has been shown and described with respect to preferred embodiments thereof, it should be understood by those skilled in the art that various changes and omissions in the form and detail thereof may be made therein without departing from the spirit and scope of the invention as defined in the appended claims.

I claim:

1. A storage safe comprising a main body including a fixed top plate and a fixed bottom plate both attached to a fixed back plate and left and right fixed partial side plates each side plate attached on three sides to the various top, bottom and back plates; hinged along the fourth side of each side plate are doors forming left and right movable doors with the doors having an “L” shaped cross-section from above and including a locking linkage means.

2. The safe of claim 1 wherein the locking means includes metal bolts which are moved by mechanical linkages and secure the doors in a closed position to the main body and to each side door to the other.

3. The safe of claim 1 including surfaces upon which mounting apparatus may be attached to support firearms and other items displayed therein.

4. The safe of claim 1 having fire resistant materials installed therein.

5. The safe of claim 4 having fire resistant door seals.

6. A display case and storage safe for bettering the display and storage characteristics of firearms comprising:
a fixed back plate and a moveable door, a display surface included upon at least a portion of at least one of the fixed back plate and the moveable door, at least a portion of the display surface including mounting apparatuses capable of mounting displayed firearms, at least one displayed firearm being:
restrained by the mounting apparatuses; and
associated in a particular orientation relative to and with a portion of the display surface;
at least one mounting apparatuses oriented and configured relative to the at least one displayed firearm and
at least a portion of the display surface so that during operations of the moveable door the at least one displayed firearm is restrained by the at least one mounting apparatuses in such a way that the at least one displayed firearm is fixed in the particular orientation relative to the portion of the display surface during velocities and decelerations associated with operations of the moveable door, the bettered display and storage characteristics of firearms selected from a group consisting of eliminated firearms transfer, eliminated damage to firearms, saved spaced, eliminated tedium and eliminated risk.

7. The firearms display case and storage safe of claim 6 where the moveable door is “L” shaped when viewed perpendicular to a plane bisecting and perpendicular to its long dimension.

8. The firearms display case and storage safe of claim 6 where the moveable door is “L” shaped when viewed perpendicular to a plan bisecting and perpendicular to its long dimension, the moveable door further comprising a shorter side.

9. The firearms display case and storage safe of claim 6 further comprising a fixed side plate.

10. The firearms display case and storage safe of claim 6 further comprising a fixed partial side plate connected to the moveable door.

11. The firearms display case and storage safe of claim 10 where the fixed partial side plate connects to the moveable door by hinges.

12. The firearms display case and storage safe of claim 11 where the moveable door is “L” shaped when viewed perpendicular to a plane bisecting and perpendicular to its long dimension, the “L” shaped door further comprising mounting apparatuses for the restraining of at least one displayed firearm to the portion of the display surface in such a fashion that the at least one displayed firearm is immobilized during shutting movement velocities and decelerations of the moveable door.

13. The firearms display case and storage safe of claim 12 where mounting apparatuses capable of restraining displayed firearms include a vertically oriented arm.

14. The firearms display case and storage safe of claim 6 where operations of the moveable door include transitioning from:
a display mode to a secure storage mode; and
a secure storage mode to a display mode.

15. The firearms display case and storage safe of claim 14 where the moveable door further includes a shorter side.

16. The firearms display case and storage safe of claim 15 where the fixed back plate further comprises heavy steel plate.

17. The firearms display case and storage safe of claim 15 where the fixed back plate and moveable door further comprise a material selected form a group consisting of: heavy steel plate and vault grade laminate.
